(19) United States
(12) Patent Application Publication
(10) Pub. No.: US 2002/0131536 A1
(43) Pub. Date: Sep. 19, 2002

(54) Method and apparatus for timing recovery in signal combiner

(75) Inventor: Benoit R. Veillette, Shrub Oak, NY (US)

Correspondence Address: Jack E. Haken, Corporate Patent Counsel, U.S. Philips Corporation, 580 White Plains Road, Tarrytown, NY, 10591, US

(73) Assignee: Koninklijke Philips Electronics N.V.

(21) Appl. No.: 09/809,570

(22) Filed: Mar. 15, 2001

(51) Int. Cl. H04L 1/02; H04B 7/10

(52) U.S. Cl. 375/347

(57) ABSTRACT

Discrete time oscillators (DTO) of the sample rate converters of a diversity receiver are coupled such that only a master of the DTOs may prompt a new datum in synchrony with its respective signal. The master DTO generates a clock strobe that is propagated to all the other DTOs. Independent samples are thus synchronized, permitting them to be combined.

### BACKGROUND OF THE INVENTION

1. Field of the Invention

The invention relates to the synchronous combination of signals from multiple channels subject to continuous and/or transient mutual phase differentials.

2. Background

Urban environments can cause radio signal echoes, generating deep nulls in the signal spectrum at a receiver (signal faintness at certain frequencies). These nulls prevent error-free operation of the receiver. A well-known approach to the problem of deep fading nulls is called antenna diversity. Simply put, a single receiver (or “decoder”) can simultaneously receive signals from multiple antennas, positioned in different locations and sometimes having different properties. The benefit of using separate antennas that are spaced apart is that it minimizes the chance that echoes will simultaneously cancel the signal at all the antennas. The signals received at all the antennas are combined in various ways, the general technique going by the term: “antenna diversity.”

One type of antenna diversity has been used for some time. In this type, separate receivers are provided for each antenna. When one receiver's output drops below that of another's, the stronger decoder is switched in and the bad decoder output is switched out. Switching may also be accomplished prior to the input to the receiver. Still another type of system monitors the phase relationship between the signals received at each antenna and when a cancellation effect is detected (signal interruption), logic circuitry adjusts the phase of one antenna to augment that of the other antenna.

Modern technology offers the capability of combining the information obtained from multiple antennas with digital processors. The signals from the antennas are sampled and combined as numbers. The present invention relates to such systems, called linear diversity combining systems. It happens that one of the applications of the output signal is the reception of radio signals, but the technology could be used in any application where the outputs of two coherent receiving systems are linearly combined to generate an overall system output. The more generic term, “decoder” may be used to identify the device that receives signals.

Referring to FIG. 1, in an example of a system in which the problem of combining two signals is manifest, each of two antennas A and B receives a broadcast signal. A respective analog front-end 10, 11 filters and down-converts (translates the raw signal to a lower frequency) the raw signal. The down-converted signal is then sampled by an analog-to-digital converter (ADC) 20, 21. A digital front end 30, 31 corrects any carrier frequency or sampling frequency error with the help of synchronization (sync) detectors 40, 41. In some cases, depending on the application and design details, the digital front end 30, 31 also further down-coverts the signal to a base band frequency (the frequency of the original signal before being combined with a carrier for transmission). The digital front end 30, 31 may further condition the signal depending on the qualities of the original signal and also clean up interference. The digital front end 30, 31 may also be used to control the analog front end 10, 11 to insure that the full dynamic range of the ADC 20, 21 is utilized.

A beam-former 50 combines the signals from the two signal paths 5, 6. The beam-former 50 is composed of two feed-forward equalizer sections which help to reduce the impact of signal echoes that are in the received signal of the respective antenna. Their tap coefficients may be updated from the combined output using the constant modulus blind equalization algorithm. Their outputs are applied to an adder 47. Long echoes are thereafter attenuated by a decision feedback equalizer 45. The signal is finally output and may be further conditioned by error correction and/or other circuitry.

It can be demonstrated that the two antennas A and B spaced apart by some distance—ideally about half the wavelength of the signal they are receiving—will be less susceptible to identical nulls in their received spectra. But these antennas will also, by virtue of being spaced apart, receive signals that are out of phase with respect to each other. Differences in the time it takes for the same signal to reach one antenna versus the other can be ignored, but the phase problem is significant. In addition, the phase relationship can change over time, so the phase relationship is not predictable. There is a need in the prior art for a method of synchronizing the two signal paths, before combination, with low complexity, minimal cost, and high performance.

### SUMMARY OF THE INVENTION

Briefly, multiple signal paths, each corresponding to one antenna of a diversity antenna system, are combined by clocking the sample rate converters of each signal path from a master clock. In an embodiment, the master clock is provided by a discrete-time oscillator (DTO), which is a component of the sample rate converter of a master signal path. The multiple signal paths are linked to receive the clock strobe indicating the timing for each new sample of the respective signal path. The master signal path in the embodiment need not remain constant. For example, it can be determined by switching to the signal path that currently has the best signal quality.

The invention will be described in connection with certain preferred embodiments, with reference to the following illustrative figures so that it may be more fully understood. With reference to the figures, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

### BRIEF DESCRIPTION OF THE DRAWINGS

FIG. 1 is a figurative diagram of a diversity receiver for purposes of illustrating a system in which the problem of synchronizing signal paths arises.

FIG. 2 is a figurative diagram of a receiver component that may be used to implement an embodiment of the invention.

FIG. 3 is a diagram of a voltage-controlled oscillator driving a sample and hold circuit for controlling sampling in a receiver.

FIG. 4 is a diagram of a free-running oscillator driving a sample and hold circuit for controlling sampling in a receiver in which interpolation is used for sample timing selection.

FIG. 5 is a diagram of a time-segment of a signal for illustrating a relationship between ADC samples and synchronous demodulator samples.

FIG. 6 is a diagram of a discrete time oscillator used for controlling demodulation of a single signal channel.

FIG. 7 is a diagram of portions of respective channel decoders whose DTOs are coupled to synchronize samples and add them according to an embodiment of the invention.

FIG. 8 is a diagram illustrating details, including the coupling, of the DTOs of FIG. 7.

FIG. 9 is a state diagram illustrating a method for controlling the master/slave roles of the DTOs of FIGS. 7 and 8.

FIG. 10 is an illustration of diversity signals for illustrating certain features of an embodiment of the present invention.

### DETAILED DESCRIPTION OF THE PREFERRED EMBODIMENTS

Referring to FIG. 2, the datapath architecture of an integrated circuit (IC) that may be used as a starting point for the design of the principal embodiment, without an error correction portion, receives samples from an ADC (not shown). The output of the ADC is applied to a carrier recovery loop 106, which includes a carrier recovery (CR) block 105 and a carrier error detector (CED) block 115. In the carrier recovery loop 106, the CR block 105 aligns the carrier of the input signal to DC with the help of the CED block 115 to cancel phase noise introduced by a tuner local oscillator (not illustrated) in the analog front end 11 preceding the ADC. The carrier recovery loop may also be located at other positions in the signal path 101. A sample rate converter (SRC) 100 resamples the signal at the output of the ADC to twice the symbol frequency. A square root raised cosine (SQRC) filter 110 performs matched filtering, a technique for removing parts of the signal that do not conform to the expected shape of the signal. This filter may be shaped to remove the pilot of the signal. The output of the SQRC 110 is applied to, and used by, a timing error detector and filter block (TEDF) 120 to estimate the timing epoch forming a timing recovery loop 107. The TEDF determines the phase difference between the current base band signal and the ideal sampling instant. The TEDF may accomplish timing error detection and filtering by any suitable means. The output signal of the SQRC 110 is then partly equalized by a feed-forward equalizer (FFE) 125 to permit the segment sync pattern to be extracted by a segment synchronization detector (SSD) 130. Finally, a main equalizer, composed of a FFE section 135 and a decision feedback equalizer (FBE) section 140, compensates for multipath interference before error correction is performed beyond this stage of signal conditioning.

The timing recovery loop 107 is a critical sub-system of the digital front end 31. Its main purpose is to derive from the signal a timing epoch that will lead to the smallest symbol error rate. From this timing epoch, which defines a demodulation clock, the timing of all blocks downstream of the SRC 100 will be based. The frequency of the demodulation clock is nominally twice the symbol rate. The SRC 100 therefore ministers between three clock signals: the system clock, the ADC clock and the demodulation clock. The components of the timing recovery loop 107, the SRC 100, the TEDF 120 are discussed below in greater detail.

Sample Rate Converter

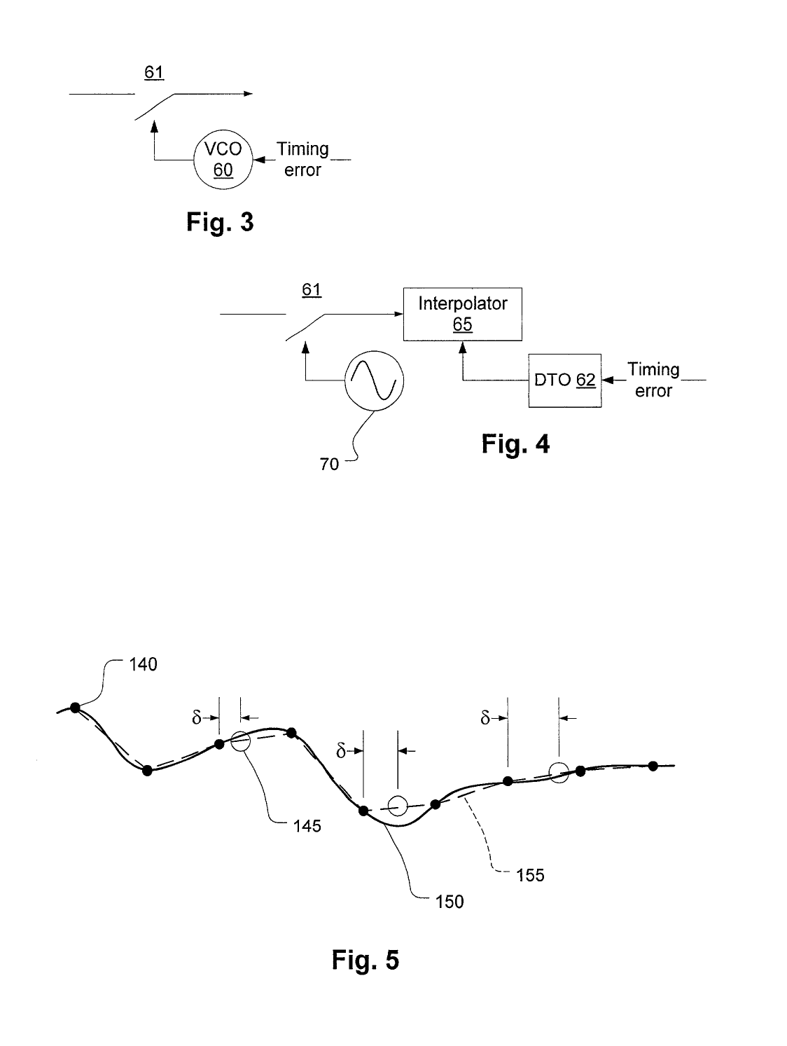

Proper demodulation requires a signal sampled at the optimum timing epoch to minimize error rate. Since the symbol clock phase is unknown to the receiver and since this rate may vary slightly at the transmitter, the receiver must be capable of adjusting the demodulation clock which governs the symbol sampling rate. Referring to FIGS. 3 and 4, this can be accomplished in the analog domain by a voltage-controlled oscillator (VCO) 60 driving a sample and hold circuit 61, which is part of the ADC. However, a VCO requires significantly more discrete components than a free running oscillator 70. Therefore, timing recovery in the digital domain is preferred as illustrated in FIG. 4. A free running oscillator 70 drives the sample and hold circuit 61 and a discrete-time oscillator (DTO) 61 controls an interpolator 65 to provide samples governed by the demodulation clock.

FIG. 5 illustrates the process of resampling using linear interpolation to derive samples at the demodulator sampling frequency. The solid points 140 represent ADC samples of the analog signal 150 indicated as a solid line. The sampling instants 145, represented by hollow points, are generated by the SRC 100 under control of the TEDF 120. The analog of the signal 150 produced by linear interpolation is indicated by a broken line 155. Linear interpolation can result in an error relative to the original signal. Indeed, linear interpolation may result in distortion levels that are unacceptable in some applications. To circumvent this problem, higher order interpolation can be employed or the signal can be upsampled before linear interpolation is performed.

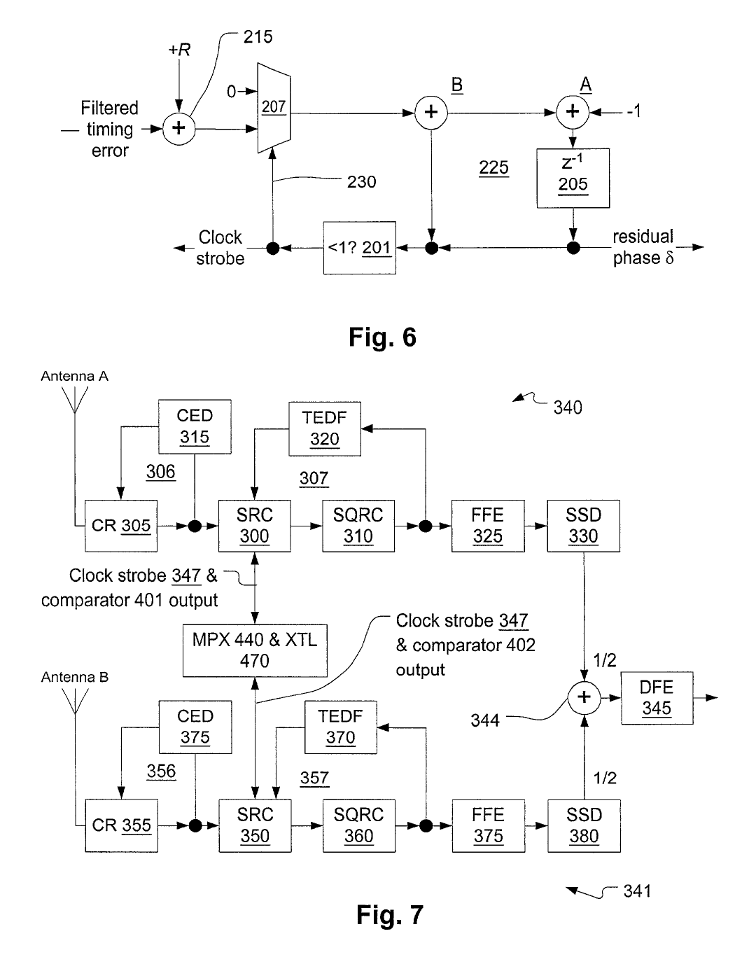

Establishing the timing of the demodulator sampling instants 145 relative to the ADC sampling instants is required for interpolation. Referring to FIG. 6, the residual phase, δ, is obtained from a discrete-time oscillator (DTO) 160. In this circuit, the signals represent the phase in units of the ADC clock cycle, 1 being equal to a full ADC clock cycle. A ratio of the input frequency over the output frequency R is applied to a multiplexer 207 which outputs 0 when its control input 230 is false and a corrected ratio R (corrected by an offset represented by the filtered timing error, via an adder 215) when its control input is true. The value output by the multiplexer 207 enters a feedback loop 225 in which the initial value R-corrected (by the filtered error and by any residual left in the feedback loop 225 when the loop was reset by the control input), is decremented by 1 by adder A at each ADC clock cycle. (Adder A and a register 205 form a frequency to phase translator.) Once the value in the feedback loop 225 falls below 1, (determined by a comparator 201), a clock strobe is generated and the sum of the parameter R and the filtered timing error are added to the phase in the loop 225.

The clock strobe causes a new sample to be calculated by interpolating between a current ADC sample and a next one according to the residual phase, δ. At each clock strobe, the residual phase is bounded by virtue of the feedback loop 225 to remain in the interval between 0 and 1. Practically, this means the position of the interpolated sample will always be between the current ADC sample and the previous one. The clock strobe is used to gate the system clock to generate the clock signal of all blocks downstream of the SRC.

Diversity Receiver Architectures

As discussed above, in a diversity receiver, the timing epoch, determined by a timing recovery loop, may differ in each channel due to different multipath characteristics and incorrect frequency recovered from one of the channels may result from severe conditions. However, the beam-former cannot tolerate timing discrepancies; each datum from a channel must match with a datum from the other channel.

Locked-Clock Dual Timing Recovery Loops

In the preferred embodiment, the phase difference between the two signals is handled in the SRC. While the phase of each channel is independent of the other, a single clock is used. The SRC of one of the channels, labeled master channel, is responsible for generating this clock signal for both channels. This scheme is illustrated in FIG. 7.

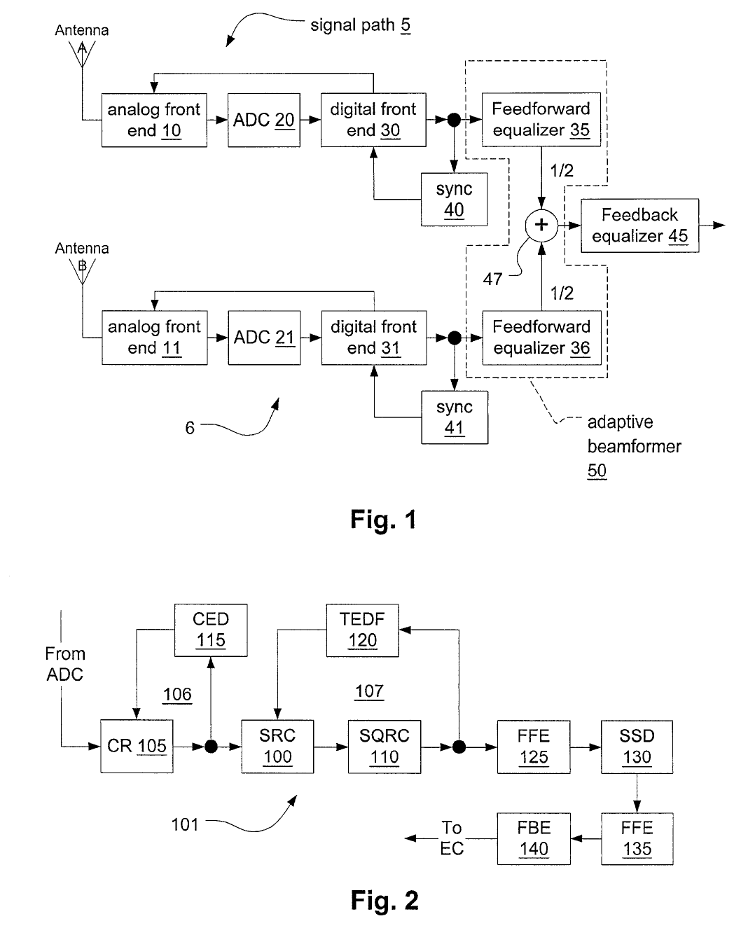

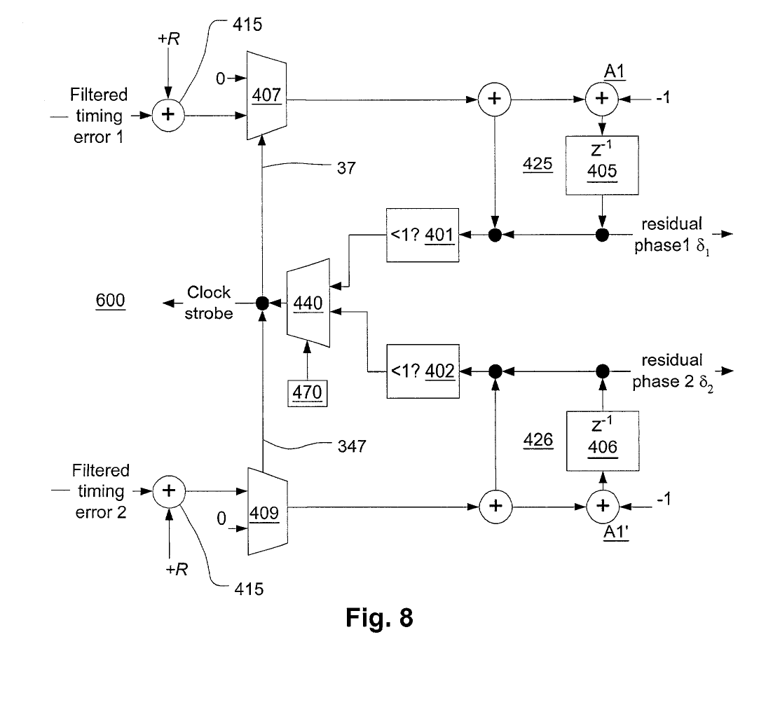

Referring to FIGS. 7 and 8, as in FIG. 1, there are two signal paths 340, 341, one for each channel C1, C2. The DTO function of the SRCs 300, 350 are linked as shown in FIG. 8, to form a sample timing oscillator 600 as indicated. Thus, there is only one controller 470 and one multiplexer 440 in the resulting sample timing oscillator 600, but it otherwise functions as described with reference to FIG. 6. In FIG. 8, in a sample oscillator 600 altered for locked-clock dual timing recovery loops both the frequency-to-phase converters (Adder A1, A1′ and register 405, 406) and the feedback loops 425, 426 are duplicated. On the other hand, a multiplexer 440 selects a single channel to control the clock strobe 430 generation. This sample oscillator 600 has slightly different properties from the one illustrated in FIG. 6. Among these differences: while the residual phase, δ₁ of the master channel is bounded by 0 and 1, that of the slave channel is not. The channel that is currently the master is preferably set by a controller 470 that deals with overflow due to loss of signal tracking. Thus, in practice, the SRC implementation may only cover a finite range of values for δ₂. Exceeding these limits defines an under- or overflow exception, with which the architecture discussed below is capable of dealing.

Focussing now on FIG. 7, a master (selected by the controller 470) of two SRCs 300 generates a strobe 347, which is used by a slave SRC 301 for its strobe to time the sample instance. The master SRC 300 may lag or lead the slave SRC 301, so the slave's residual phase δ must, therefore, be permitted to go outside the range of 0 to 1. The carrier recovery loop 306, 356 again cancels phase noise introduced by a tuner local oscillator (not illustrated) in each analog front end 11 preceding each ADC. A clock strobe 347 is transmitted from SRC 300 to SRC 350 or vice versa depending on which channel is currently selected to be the master channel.

The above embodiment is particularly suited to the 8-VSB (eight-level vestigial sideband) modulation format. However, the basic technique is suitable for QAM (quadrature amplitude modulation) and other broadcast modulation formats.

Channel quality may be sensed to handle exceptions generated by the receiver as discussed below. One measure is the magnitude of the largest tap of the FFE 325, 375. This normally indicates the strength of the most significant propagation path. However, this metric does not take into account the interference of other paths. Also, this measure is only relative to the other channel; it is not an absolute measure of channel quality.

Another metric that can be used, if the incoming signal is 8-VSB as in the current embodiment, is the segment synchronization correlation strength determined by the SSD 330, 380. The sign of the segment synchronization pattern is correlated at each of 832 possible locations over a number of frames. The main drawback is that it is not very discriminating; the channel is either good or bad. While this can be a limitation for diagnosis, it is sufficient for the control of the embodiments described above.

Yet another option for channel quality is via lock detectors which typically monitor the timing error as detected by the TEDF. If there are no deviations larger than a pre-established threshold above or below the mean value then the loop is said to be “locked.” Based on this idea, it would be a fairly trivial exercise to construct a RMS jitter meter that measured the variation in the sampling instants. The instantaneous value of the sampling instant could be subtracted from its DC component obtained using a lowpass filter. The RMS of the output would be the RMS jitter value. This circuit would be expensive to implement. It would also require modifications to the SRC since the absolute value of the sampling instant is required while only the value relative to the clock strobe is calculated.

Other possibilities could arise in connection with alternative applications, depending on the particular technology used.

Three possibilities must be considered for phase range exceptions.

Phase Range Exception with Good Master Channel

One type of error that may occur is where the slave channel phase falls outside a reasonable (predetermined limit) range because the slave channel is adversely affected. Since, in this case, the clock signal is generated by the good channel, the exception is the least severe. Three options are possible. The easiest one is to give up on the bad channel and ignore it altogether. The second possibility is to override the control of the SRC of the bad channel with the phase of the good channel. The last solution is to bring back the residual phase of the slave channel in the acceptable range and hope that it will eventually lock. To minimize the TEDF disturbance that will result from such a phase jump, it is desirable to add or subtract some multiple of the symbol time scale, in the case of 8-VSB for example, 4R. This feedback value corresponds to two symbols, the inverse of the bandwidth of the SQRC filter. If this is not possible because of limited delta range, then +/−2R, a symbol duration, may be added.

Phase Range Exception with Good Slave Channel

Another exception that can occur is where the master channel causes the slave residual phase to go outside the predetermined range. Obviously, in this case, the master and slave roles should be reversed. The feedback circuit will ensure that the residual phase of the new master is brought back within the range of 0 to 1. Since the phase of the previously slave, good channel was independent of the bad channel and accurate, the recovery is seamless. In the process, the new slave residual phase may go out of bound and trigger another exception where the master is now the good channel. This may be handled as specified in the previous paragraph without resulting in any performance impact on the good channel.

Phase Range Exception with No Good Channel

The last possibility is for a phase exception to occur while there is no unambiguous indication of a good channel. This may occur because both channels are bad or because one of them is good but is in the process of locking and the quality detector is not conclusive. For a given time duration, it should be assumed that the master channel will eventually reach a state of adequate reception. In the interval the residual phase of the slave channel should be adjusted to lie in the acceptable range as described above. After this period, if none of the channels has achieved a lock, the digital front end should be reset and the master/slave channel roles should be switched.

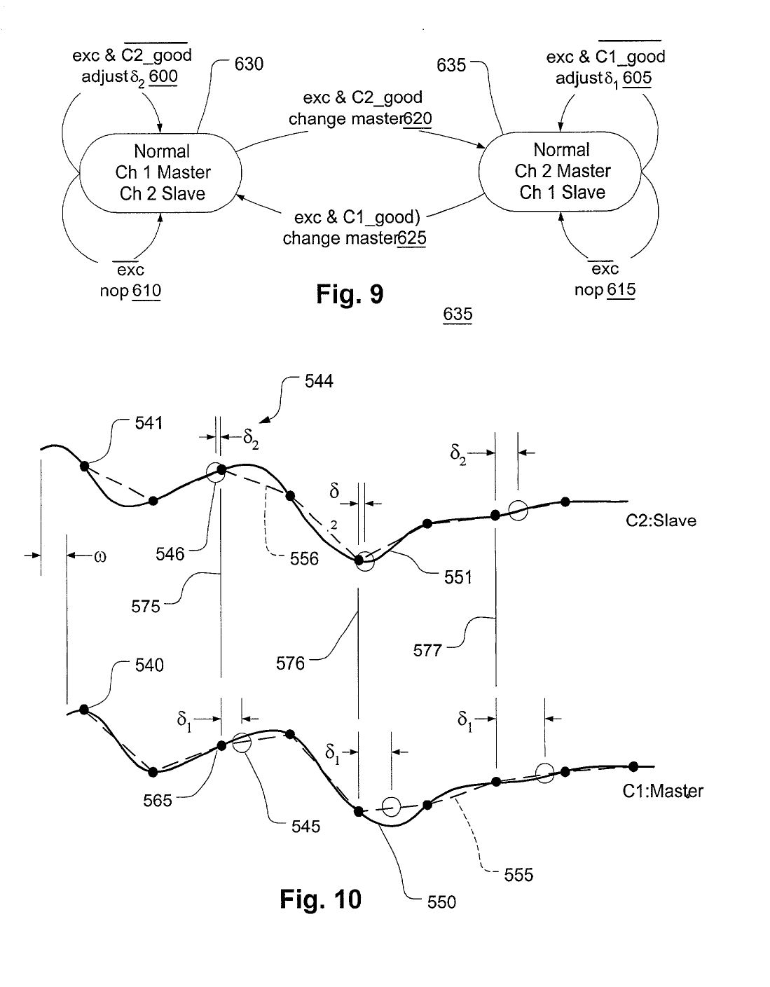

FIG. 9 illustrates a simplified state diagram incorporating the above rules. The state machine input signals include “exc,” indicating a phase exception in the DTO; “C1_good,” the quality indicator for channel 1; “C2_good,” the quality indicator for channel 2. The overbar indicates negation. As discussed above, exceptions occur when one of the residuals (δ₁ or δ₂) goes outside of a preselected range. For example, the range may be approximates +/−2R. If channel 1 is the master channel (630) and an exception occurs with channel 2 not proven good (600), then δ₂ is adjusted by subtracting (for an overflow) or adding (for an underflow) some quantity that (preferably) brings it back in the allowed range. Preferably a value of +/−4R is added. If no exception occurs, no special operation (“nop” transition in FIG. 9) is necessary. If channel 2 is the master channel (635) and an exception occurs with channel 1 not proven good (605), then δ₁ is adjusted by subtracting (for an overflow) or adding (for an underflow) some quantity that (preferably) brings it back in the allowed range. If no exception occurs, no special operation occurs. If channel 1 is master (630), an exception occurs, and channel 2 has good signal quality (620), then channel 2 may be made the master channel. If channel 2 is master (635), an exception occurs, and channel 1 has good signal quality (625), then channel 1 may be made the master channel.

The above-described dual timing recovery loop architecture permits independent sampling instants. It should thus achieve optimum performance since independent timing instants are allowed. However, the implementation is simple since only one clock is generated for both channels, alleviating the need for complex interfaces such as a clock bridge. Since the SRC filter 300, 350 and the SQRC filter 310, 360 of both channels operate on the same clock frequency, it is easy to time-share a single datapath. Also, recovery from an exception, where one channel is good, does not require a front end reset.

Referring to FIGS. 7, 8, and 10, base band signals 550 and 551 represent first and second channel signals before sampling. In FIG. 10, each solid point represents an ADC sample 540, 541 and each hollow point represents a sample instant 545, 546. The broken lines 555, 556 represents a model of the base band signal derived by linear interpolation of the ADC samples 540, 541. The base band signal received by the second channel leads the base band signal received by the first channel by a phase difference ω. The first channel C1 is a master channel and as such, a clock strobe 347 is generated by it, but as discussed below, the master/slave relationship may alternate between channels. Each time the first channel C1 calculates that a sample instant is between a current ADC cycle and the next ADC cycle, it generates the clock strobe 347 (in FIG. 7), 575, 576, 577 (in FIG. 10). Since both the slave and master feedback loops 425, 426 are incremented (by R-adjusted by filtered timing error and the prior residual δ₁, δ₂) at the same time (corresponding with the clock strobe), the slave channel residual 62 may be negative or greater than 1. As shown in FIG. 10, the first slave channel residual 62 (indicated at 544) is negative, while the rest of the slave and master channel residuals δ₁, δ₂ are in the range of 0 and 1. Note that if ω were greater than an ADC cycle or if one of the channels loses synch, the slave channel residual 62 could exceed 1.

It will be evident to those skilled in the art that the invention is not limited to the details of the foregoing illustrative embodiments, and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

Thus, for example, although in the embodiments of a diversity receiver described above, as in the claims, there are only two channels employed, it is clear that the invention may be extended to embodiments including any number of multiple channels with one master and many slaves. Moreover, while a simple control algorithm for controlling the master/slave roles is disclosed, there are a variety of control systems that could be employed including one that merely allows the master to be permanently preselected.

Although claims may refer to first and second channels, antennas, etc., without explicitly reciting “at least first and second . . . ” it is clear, and intended, that they should be understood to embrace devices that include more than two channels, antennas, etc., respectively. Also, although in the embodiments described above a DTO of each channel was used to create a strobe for designating the timing of sampling instants, it is a trivial modification of the design to provide a separate device for creating the strobe signal and slaving all the SRCs to this same strobe. In that case, there would be no master channel, but rather a single master strobe signal derived by locking with the input signal.

What is claimed is:

1. A device for combining first and second signals, comprising:
a first detector configured to generate first samples synchronized with said first signal at first times responsive to said first signal;
said first detector being configured to generate first indicator signals indicating said first times and to apply said first samples to a first signal path at times corresponding to said first times;
a second detector configured to generate second samples synchronized with said second signal at second times responsive to said first indicator signals;
said second detector being further configured to apply said second samples to a second signal path at times corresponding to said first times;
a signal combiner connected to receive said first and second samples from said first and second signal paths and configured to combine said first and second samples to output a combined signal resulting therefrom.

2. A device as in claim 1, wherein said signal combiner is an adder configured to add said first and second samples.

3. A device as in claim 1, further comprising:
a controller;
said second detector being further configured such that said second times are responsive to said second signal and to generate second indicator signals indicating said second times responsive to said second signal when said second detector is in a master mode;
said first detector being further configured to generate said first samples synchronized with said first signal at said first times responsive to said second signal when said second detector is in said master mode;
said controller being programmed to place said second detector in said master mode responsively, at least in part, to a loss by said first detector of synchronization with said first signal.

4. A device as in claim 3, wherein said signal combiner is an adder configured to add said first and second samples.

5. A device as in claim 1, further comprising:
first and second antennas spatially separated;
said first and second signals being derived from said first and second antennas, respectively.

6. A method of combining first and second signals, comprising the steps of:
receiving a first signal and synchronizing with said first signal to identify first sample instants corresponding to a rate of a first symbol signal embedded in said first signal;
receiving a second signal and synchronizing with said second signal to identify second sample instants corresponding to a rate of a second symbol signal embedded in said second signal;
combining first and second samples corresponding to said first and second sample instants in synchrony with said first sample instants.

7. A method as in claim 6, wherein:
said first and second signals are substantially identical signals which may, at times, be related by a phase difference; and
step of combining includes combining samples that correspond to same temporal portions of said first and second signals, whereby said first and second samples are synchronized.

8. A method as in claim 6, wherein said first and second signals are derived from respective antennas spatially separated.

9. A method as in claim 6, wherein said step of combining includes adding values proportional to said first and second samples, respectively, whereby a weighted sum is generated.

10. A method as in claim 6, further comprising combining first and second samples corresponding to said first and second sample instants in synchrony with said second sample instants.

11. A method of synchronizing first and second signals from respective first and spatial diversity antennas, comprising the steps of:
demodulating said first signal to generate first symbol sample signals;
demodulating said second signal to generate second symbol sample signals;
synchronizing said first and second symbol sample signals;
summing corresponding pairs of said first and second symbols sample signals;
said first and second steps of demodulating being responsive to a timing signal derived from only one of said first and second signals.

12. A method as in claim 11, wherein said timing signal is generated responsively to a result of at least one of said steps of demodulating such that said one of said first and second signals is changed responsively to said result.

13. A signal combiner including a sample rate converter for resampling at least first and second transmitted signals at a multiple of a symbol frequency of an information signal embedded in said at first and second transmitted signals, comprising:
an oscillator, connectable to at least one of said first and second input signals, and configured to generate a clock signal indicative of symbol rate detected in said at least one of said first and second input signals;
first and second sampling circuits connectable respectively to said first and second transmitted signals, said first and second sampling circuits being configured to determine a timing for sampling said first and second transmitted signals and output samples resulting thereby in synchrony with said clock signal.

14. A signal combiner as in claim 13, further comprising a signal-summer, wherein said first and second sampling circuits are connected to output said samples to said signal-summer.

15. A signal combiner as in claim 13, wherein said oscillator is a portion of one of said first and second sampling circuits such that said clock signal is responsive to said timing for sampling one of said first and second transmitted signals.
